(19) United States
(12) Patent Application Publication
(10) Pub. No.: US 2008/0158904 A1
(43) Pub. Date: Jul. 3, 2008

(54) Retractable light emitting decoration structure

(76) Inventor: Chi-Shih Lai, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/647,248

(22) Filed: Dec. 29, 2006

(51) Int. Cl. F21V 21/00; F21S 4/00; A47G 35/00

(52) U.S. Cl. 362/565; 362/382

(57) ABSTRACT

A retractable light emitting decoration structure comprises a detachable supporting frame, a retractable cover, and a light emitting device. The retractable cover is flexible and pervious to light. The retractable cover is sleeved outside the detachable supporting frame. The light emitting device is disposed inside the retractable cover. The retractable light emitting decoration structure can be detached and folded to reduce the volume and occupy less space so as to facilitate the product's storage, transportation, and stocking.

### BACKGROUND OF THE INVENTION

1. Field of the Invention

The present invention relates to a retractable light emitting decoration structure and, more particularly, to a retractable light emitting decoration structure which can be detached and folded to reduce its volume so that it occupies less space.

2. Description of Related Art

On important festivals households will usually furnish their houses with some decorations that symbolize the festival to enhance the mood of a festival. FIG. 1 shows a prior art decoration la. The shape of the decoration la can be designed to be that of a snowman, a pumpkin, a Christmas tree, an elf, or any other shape.

Moreover, a light emitting component can be further disposed in the decoration to project out the light. A light emitting decoration can thus be formed to achieve a better decorating effect.

The above light emitting decorations used on festivals need to be stored during ordinary times however, as there are few opportunities to exhibit the decorations other than the particular festive occasion for which they were designed. Because common light emitting decorations cannot be folded, they occupy more space causing inconvenience. Also, transporting and stocking these kinds of products can be a serious problem.

Accordingly, the present invention aims to propose a retractable light emitting decoration structure to solve the above problems in the prior art.

### SUMMARY OF THE INVENTION

An object of the present invention is to provide a retractable light emitting decoration structure, which can be detached and folded to reduce its volume so that it occupies less space making storage, transportation and stocking of the lights more convenient.

To achieve the above object, the present invention provides a retractable light emitting decoration structure, which comprises a detachable supporting frame, a retractable cover, and a light emitting device. The retractable cover is flexible and pervious to light. The retractable cover is sleeved outside the detachable supporting frame. The light emitting device is disposed inside the retractable cover.

The detachable supporting frame, the retractable cover, and the light emitting device of the present invention can be detached. Next, the detachable supporting frame can further be detached, and the retractable cover can then be folded. Therefore, the retractable light emitting decoration structure can be detached and folded to reduce its volume so that it occupies less space thereby facilitating storage, transportation and stocking of these kinds of products.

### BRIEF DESCRIPTION OF THE DRAWINGS

The various objects and advantages of the present invention will be more readily understood from the following detailed description when read in conjunction with the appended drawing, in which:

FIG. 1 is a perspective view of a prior art light emitting decoration;

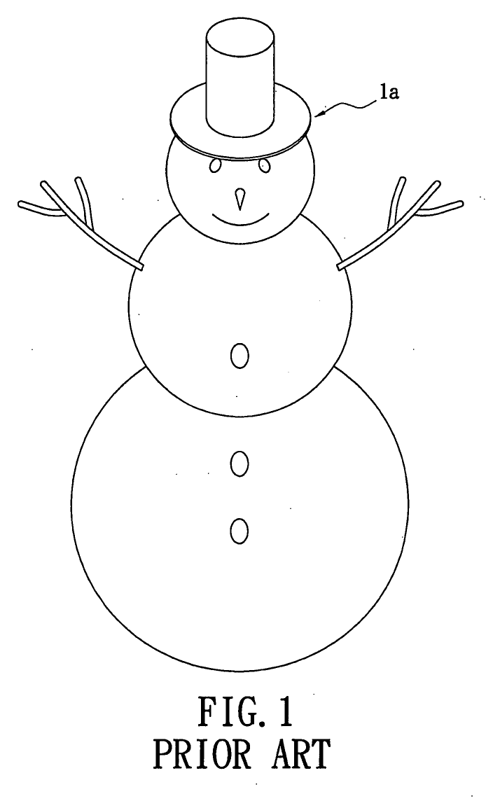

FIG. 2 is a perspective view of a light emitting decoration of the present invention in an unfolded state;

FIG. 3 is a cross-sectional view of a light emitting decoration of the present invention in an unfolded state;

FIG. 4 is a perspective exploded view of a detachable supporting frame and a light emitting device of the present invention;

FIG. 5 is a perspective assembly view of a detachable supporting frame and a light emitting device of the present invention;

FIG. 6 is a perspective view of a light emitting decoration of the present invention in a folded state; and

FIG. 7 is a perspective assembly view of a detachable supporting frame and a light emitting device according to another embodiment of the present invention.

### DETAILED DESCRIPTION OF THE PREFERRED EMBODIMENTS

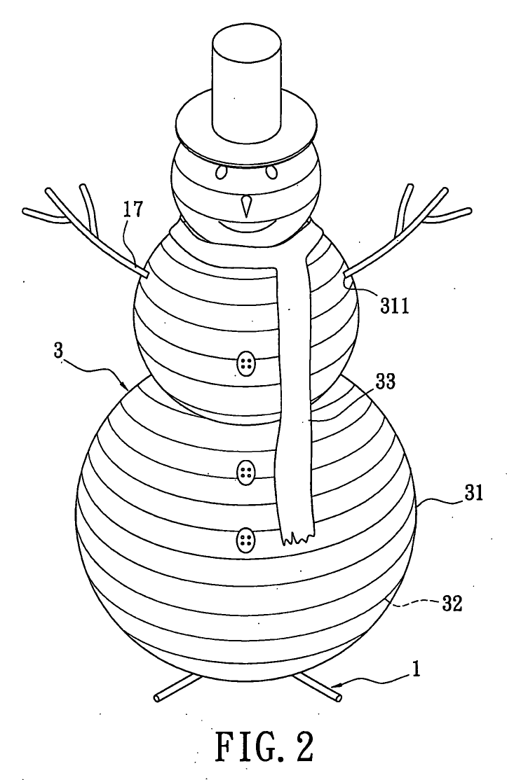

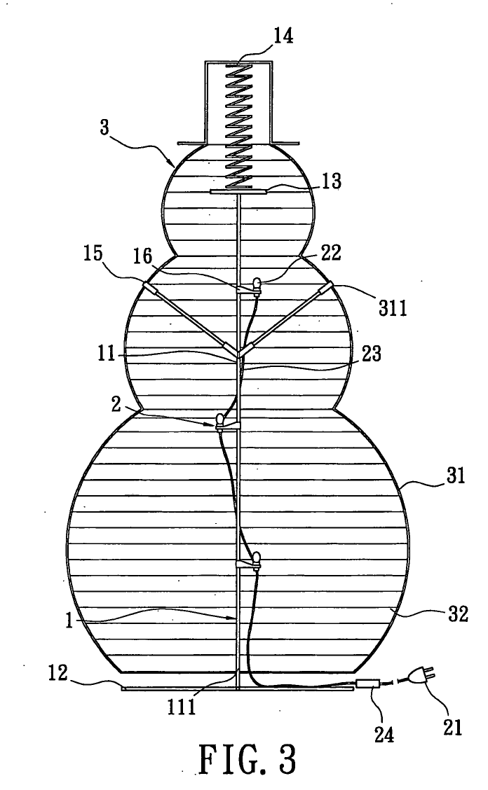

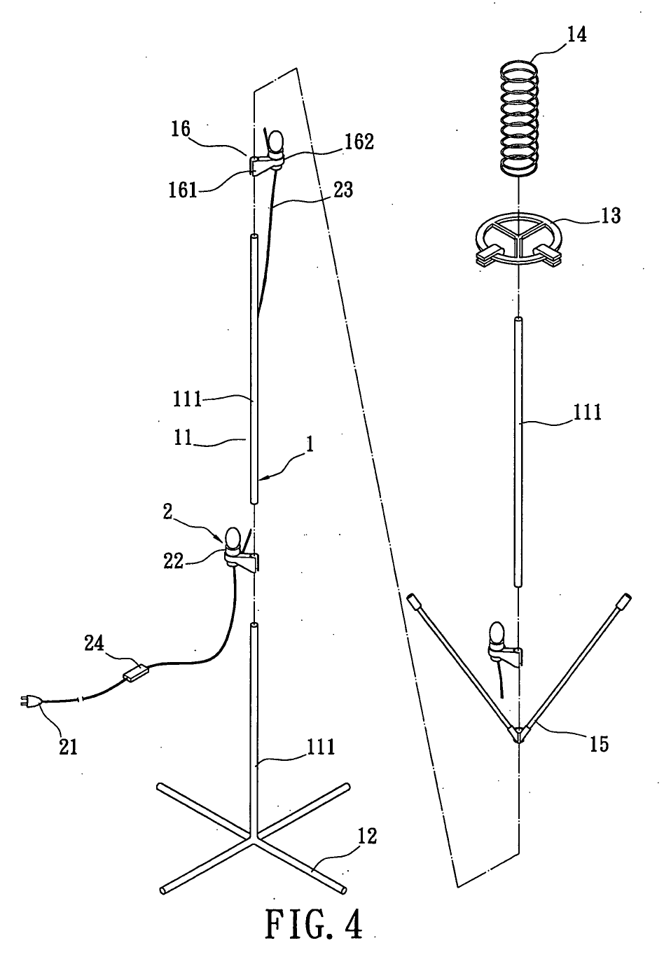

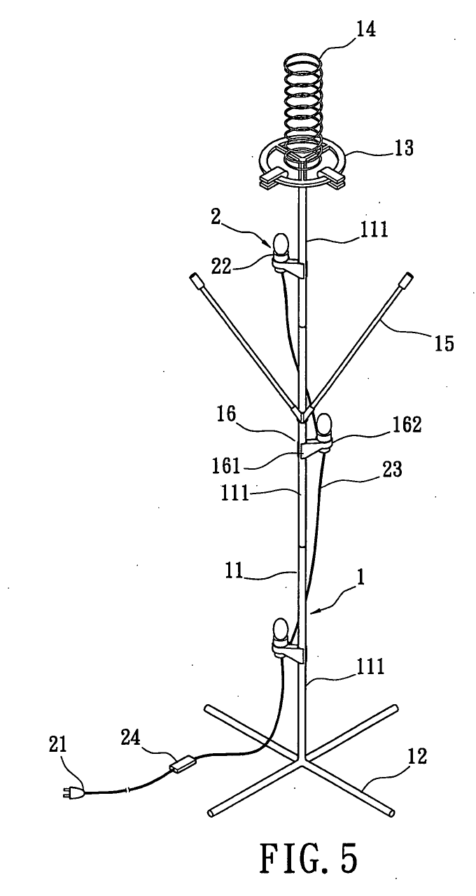

As shown in FIGS. 2 and 3, a retractable light emitting decoration structure of the present invention comprises a detachable supporting frame 1, a light emitting device 2, and a retractable cover 3. The detachable supporting frame 1 comprises a main rack 11, a base 12, a top seat 13, and an elastic component 14, as shown in FIGS. 4 and 5. The main rack 11 is composed of several rods 111 that are inserted or screwed together to give the main rack 11 a detachable structure. The main rack 11 also connects to two braces 15.

The structure of the base 12 is not limited. The only requirement is that it can be firmly placed on the ground. The base 12 is connected with the lower end of the main rack 11. The main rack 11 can thus be supported by the base 12 to stand erect so as to support the retractable cover 3 in an unfolded state.

The top seat 13 is connected with the upper end of the main rack 11. The elastic component 14 is placed on the top seat 13. The elastic component 14 is a spring. The lower end of the elastic component 14 is fixed on the top seat 13 so that the elastic component 13 can stand erect on the top seat 13.

The light emitting device 2 is disposed inside the retractable cover 3. The light emitting device 2 includes an electric plug 21, one or more light emitting components 22, and a power cord 23 electrically connecting the electric plug 21 and the light emitting components 22. The light emitting components 22 can be light bulbs, Christmas lamps, or light emitting diodes.

One or more fixing components 16 corresponding to the light emitting components 22 are disposed on the detachable supporting frame 1. The light emitting components 22 can be fixed on the detachable supporting frame 1 by using the fixing components 16. In this embodiment, each of the fixing components is a clamp having a first clamping portion 161 and a second clamping portion 162 formed at two ends thereof, and the first clamping portion 161 and the second clamping portion 162 are clamped at the main rack 11 and one of the light emitting components 22, respectively. The light emitting components 22 can thus be fixed on the detachable supporting frame 1.

The retractable cover 3 includes a cover body 31 and several rings 32. The cover body 31 is made of flexible and light-pervious material that can be conveniently folded and unfolded. The bottom of the cover body 31 is open. The shape of the cover body 31 is not limited, and appropriate decorations 33 or patterns can be arranged on the surface of the cover body 31 to let the cover body 31 have the shape of a snowman, a pumpkin, a Christmas tree, an elf, or any other shape.

The rings 32 are alternately and annularly disposed on the inner wall of the cover body 31. The rings 32 can be used to stretch out the cover body 31 to let the cover body 31 have a better 3D effect when unfolded.

The retractable cover 3 is sleeved from top to bottom outside the detachable supporting frame 1. The elastic component 14 of the detachable supporting frame 1 is propped up at the top of the retractable cover 3 so that the retractable cover 3 can be unfolded to a 3D state and sleeved outside the detachable supporting frame 1.

Two through holes 311 are provided on the cover body 31. The outer ends of the two braces 15 correspond to the two through holes 311 so that appropriate objects 17 (e.g., arms of a snowman) can be inserted or connected at the outer ends of the two braces 15.

When the electric plug 21 is inserted into a receptacle, the light emitting components 22 can emit light and project light out via the retractable cover 3 to achieve a better decorating effect. Moreover, the power cord 23 can be electrically connected to a control circuit box 24 to make the light emitting components flash off and on or light different colors, thereby accomplishing an even better decorating effect.

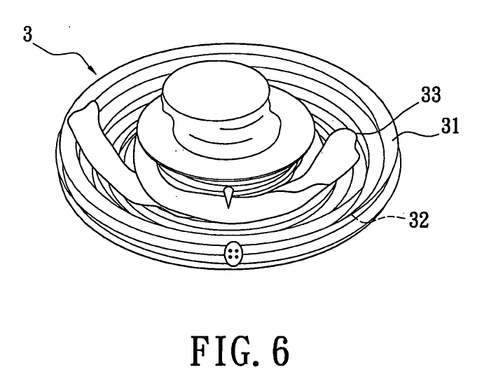

The light emitting decoration structure of the present invention adopts a combination design to facilitate assembly. When the light emitting decoration structure is not in use, the detachable supporting frame 1, the light emitting device 2, and the retractable cover 3 can be detached, Next, the detachable supporting frame 1 can further be detached, and the retractable cover 3 can then be folded (as shown in FIG. 6). Therefore, the light emitting decoration structure can be detached and folded to reduce the volume and occupy less space so as to facilitate the storage transportation, and stocking of these kinds of products.

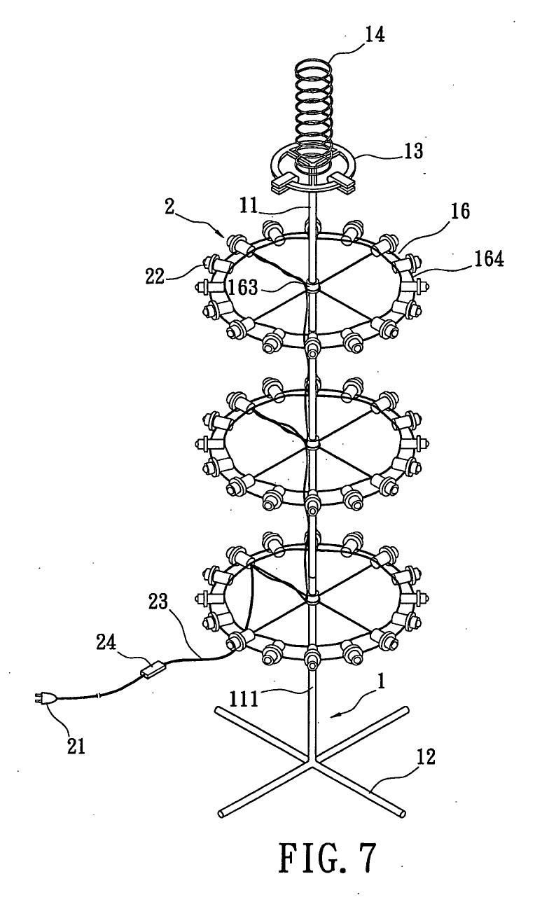

FIG. 7 is a perspective assembly view of a detachable supporting frame and a light emitting device according to another embodiment of the present invention. As shown in FIG. 7, each of the fixing components 16 is an annular rack having an inner ring 163 and an outer ring 164. The inner ring 163 is sleeved and fixed on the main rack 11. The light emitting components 22 are alternately arranged on the outer rings 164 so that the light emitting components 22 can be fixed on the detachable supporting frame 1. In the present invention, the fixing manner of the light emitting components 22 is not limited, and can vary according to practical requirements.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A retractable light emitting decoration structure comprising:
a detachable supporting frame;
a retractable cover having flexibility and a light-pervious property, said retractable cover being sleeved outside said detachable supporting frame; and
a light emitting device disposed inside said retractable cover.

2. The retractable light emitting decoration structure as claimed in claim 1, wherein said detachable supporting frame has a main rack, and said main rack is composed of several rods that are inserted or screwed together.

3. The retractable light emitting decoration structure as claimed in claim 2, wherein said detachable supporting frame has a base connected with a lower end of said main rack.

4. The retractable light emitting decoration structure as claimed in claim 2, wherein said detachable supporting frame has a top seat connected to an upper end of said main rack, an elastic component is disposed on said top seat, and said elastic component is propped up at a top of said retractable cover.

5. The retractable light emitting decoration structure as claimed in claim 1, wherein said retractable cover includes a cover body and several rings, said cover body is flexible and pervious to light, and said rings are alternately and annularly arranged on an inner wall of said cover body.

6. The retractable light emitting decoration structure as claimed in claim 1, wherein through holes are disposed on said retractable cover, braces are connected with said detachable supporting frame, outer ends of said braces correspond to said through holes, and objects are connected at the outer ends of said braces.

7. The retractable light emitting decoration structure as claimed in claim 1, wherein a bottom of said retractable cover is open, and said retractable cover is sleeved from top to bottom outside said detachable supporting frame.

8. The retractable light emitting decoration structure as claimed in claim 1, wherein decorations or patterns are disposed on a surface of said retractable cover.

9. The retractable light emitting decoration structure as claimed in claim 1, wherein said light emitting device comprises an electric plug, one or more light emitting components, and a power cord electrically connecting said electric plug and said light emitting components, one or more fixing components are disposed on said detachable supporting frame, and said light emitting components are fixed on said fixing components.

10. The retractable light emitting decoration structure as claimed in claim 9, wherein each of said fixing components is a clamp, a first clamping portion and a second clamping portion are formed at two ends of said fixing component, and said first clamping portion and said second clamping portion are clamped on said detachable supporting frame and one of said light emitting components, respectively.

11. The retractable light emitting decoration structure as claimed in claim 9, wherein each of said fixing components has an inner ring and an outer ring, said inner ring is sleeved and fixed on said detachable supporting frame, and one of said light emitting components is disposed on said outer ring.
